(19) United States
(12) Patent Application Publication
(10) Pub. No.: US 2023/0409409 A1
(43) Pub. Date: Dec. 21, 2023

(54) SITE CONVERGENCE AGENT AND ASSOCIATED METHOD

(71) Applicant: MICROSOFT TECHNOLOGY LICENSING, LLC, Redmond, WA (US)

(72) Inventors: Peter Louis WHITE, Edinburgh (GB); Calum Sutherland LOUDON, Enfield (GB)

(21) Appl. No.: 17/888,418

(22) Filed: Aug. 15, 2022

(30) Foreign Application Priority Data
Jun. 15, 2022 (GB) 2208806.6

(51) Int. Cl. G06F 9/50

(52) U.S. Cl. CPC G06F 9/5077; G06F 9/5038; G06F 2209/5019

(57) ABSTRACT

An apparatus, computer-implemented method and media for instantiating a network service, comprising: receiving a request for a required network service; determining a required network service (NS) design for the required network service storing a required NS state configured to create a list of required resources in a required order for instantiating the required network service sequencing, through the list of required resources in the required order and identifying a sequence of required resources based on the order; converging towards the sequence of required resources, via a SCA convergence by: (a) implementing the required resource by calling for the required resource to be created, updated or deleted; (b) determining a next required resource to implement; repeating steps (a) and (b) to convergence; comparing the implemented resources with the list of required resource to determine convergence; instantiating, via a controller, the or each implemented resource.

### BACKGROUND

Cloud platforms are a major contributor to the design and creation of new services. The new services enable businesses to build, operate and manage applications with bespoke tools and features over multiple clouds or other location wherever they may be.

The present deployments of new services rely on implementing the service in a bespoke, non-reusable way which means when a new instance of the same or a similar service is needed the design may have to be adapted to the new deployment. Furthermore, such bespoke services are very difficult to automate and manage.

In big, complicated networks many of the problems are exacerbated, as much of the configuration of virtual machines, containers, and other cloud resources, which implement the service or software must be done by hand. This is time consuming and error prone and relies on operator capabilities and experience which are sometimes insufficient on both counts.

The embodiments described below are not limited to implementations which solve any or all of the disadvantages of known computer platforms.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

According to the invention there is provided a computer-implemented method for instantiating a network service, comprising: receiving a request for a required network service; determining a required network service (NS) design for the required network service; storing a required NS state configured to create a list of required resources in a required order for instantiating the required network service sequencing through the list of required resources in the required order and identifying a sequence of required resources based on the order; converging towards the sequence of required resources, via a SCA convergence loop by (a) implementing the required resource by calling for the required resource to be created, updated or deleted; (b) determining a next required resource to implement; repeating steps (a) and (b) to convergence; comparing the implemented resources with the list of required resource to determine convergence; instantiating, via a controller, the or each implemented resource

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of an apparatus for a network architecture, according to the present invention.

FIG. 2 is a schematic diagram of an apparatus for a site convergence agent for use with the FIG. 1 apparatus

FIG. 3 is a flow diagram of a method using a site convergence agent according to the present invention.

FIG. 4 illustrates an exemplary computing-based device in which embodiments of the FIG. 1 architecture are implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present examples are constructed or utilized. The description sets forth the functions of the examples and the sequence of operations for constructing and operating the examples. However, the same or equivalent functions and sequences may be accomplished by different examples.

The present invention relates generally to a site convergence agent on a cloud computing platform and an associated method. This provides an orchestrated configuration of virtual machines, containerized functions, cloud infrastructure of anything that can be triggered from a cloud computing platform such as, for example, Microsoft™ Azure™.

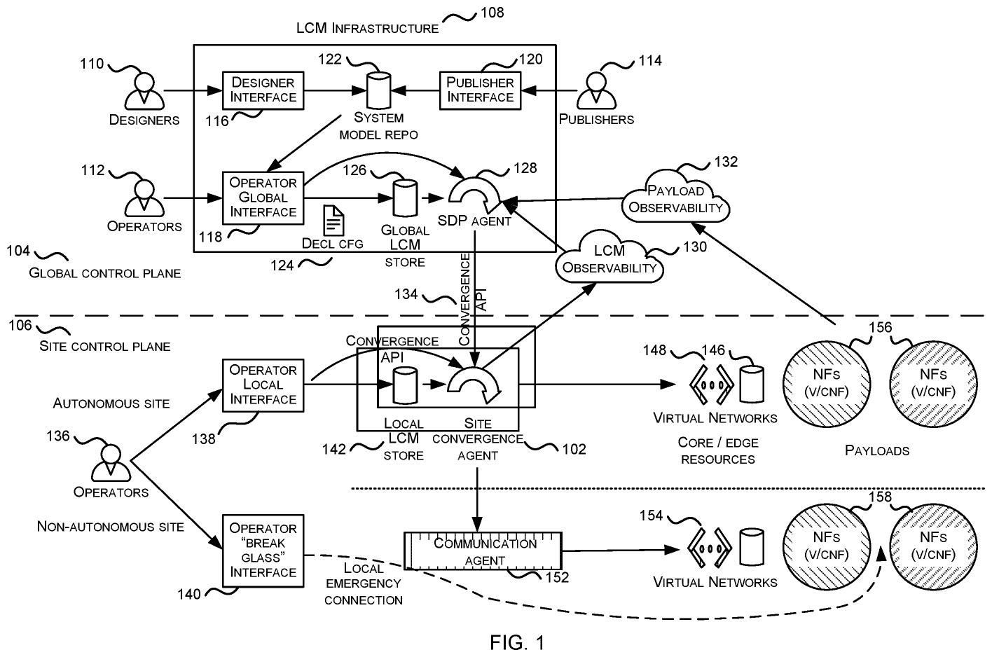

FIG. 1 is a diagram of a cloud computing platform (CCP) 100 for providing different cloud services and enabling the development and scaling of new applications and to redeploy and run existing applications.

In addition, the computing platform offers many other services and resources, one of which is running virtual machines or containers in the cloud. These compute resources host infrastructure components and support the use of third-party operating systems. A further use is as a platform for hosting databases in the cloud. Such a platform is frequently used for backup and disaster recovery.

The present invention relates to a site convergence agent (SCA) 102 which is part of the CCP 100 that receives request for the deployment of new or upgrade/reconfiguration of existing network services from local users, third parties or whoever. In accordance with the present invention the SCA 102 executes two processes or loops, one which maps network services to component network functions and one which maps network functions to resources. For the avoidance of any doubt, Network Services are big composite software applications perform complex networking functions and Network Functions are smaller software application perform functions relevant to the network service.

By using different levels of mapping and deriving the order of functions, a publisher or a designer no longer has to specify the order because the SCA 102 computes it automatically. In addition, the present invention provides the ability to extend the composition of network functions into higher-level network services.

This provides the capability of building applications or services from the bottom up in an automated manner based on an automated configuration as will be described in greater detail below.

Returning to FIG. 1 the CCP 100 includes a global control plane 104 and a site control plane 106. The global control plane 104 includes a life-cycle management (LCM) infrastructure 108 in which designers 110, operators 112 and publishers 114 are operating. Each work with a respective interface: designer interface 116, operator global interface 118 and publisher interface 120.

The designer and publisher via their respective interfaces generate a system model 122 which is shared with the operator at the operator interface 118 and a decl cfg file 124 is generated and stored in a global LCM store 126. Decl cfg means declarative configuration: that is, a description of what the operator wishes the system to look like, rather than a series of commands to get the system into that state.

The operator 112 further sends data to a Safe Deployment Practices (SDP) agent 128 which also receives input from the global LCM store 126. Safe Deployment Practices comprise rolling out changes first to one site, checking they work, then rolling them out to the next site or batch of sites and so on so as to avoid simultaneous misconfigurations of multiple sites.

An LCM observability platform 130 and a payload observability platform 132 also contribute data to the SDP agent 128 from the site control plane. The LCM observability refers to metrics and other data sourced from the SCA 102 about the success (or otherwise) of the SCA's convergence process. Payload observability refers to metrics and other data sources from the workloads being deployed and upgraded. Both LCM and payload observability data may come through the same system, but logically they are separate. The SCA 102 exposes a convergence API 134 which is then called by the SDP agent 128.

It should be noted some sites (“non-autonomous”) are not suitable/capable of hosting the SCA 102, for example because they have very limited capacity. In this case the workloads on the sites are controlled by the SCA 102 running on a separate site, and in the event of connectivity being lost to that separate site all the operators can do is use very limited “break glass” operations 140 that bypass the SCA 102 and directly manipulate the workloads.

Alternatively, those sites that do host the SCA 102 (“autonomous”) may lose contact with the global control plane. In this case, the operators 136 can still use the SCA interface 138 to request the SCA 102 to control the workloads. This is not “break glass”: the operators are invoking precisely the same SCA API that the SDP agent 128 does.

Operators 136 in the site control plane 106 operate the local interface 138 and the “break glass” interface 140. The latter enables fast and easy emergency access control for authorized users to certain resources outside the scope of the normal interface. The operators 136 may be remote to or autonomous with the global control plane 104

Operator 136 may interact directly with the SCA 102 which uses the same API 134 to the SCA 102.

The SCA 102 uses a Network Service definition and NF definitions (in the system model repo 122) to compute a list of resources that should exist in order to match the inputs provided across the convergence API 134; it then uses its knowledge which is obtained from the cloud platform of what resources do exist. The list is worked through in sequence based on the required order. The SCA 102 computes the difference and decides what resources to create/update in what order. A virtual network 148 is an example of the sort of resources that might need to exist. The SCA 102 creates or configures infrastructure resources 146, 148 and the NF resources 156 associated with the system and workload resources (such as VMs or containers) as specified by their definitions as stored in the system model repo 122 and referenced across the API 134. The list of resources is that which are required to instantiate the required network service and is referred to as a required ordered list or a required sequence of resources.

In addition to deploying resources locally in the same region as the SCA, they may be deployed in a remote location. The ARC agents 152 are a communications channel to a remote platform. Resources 158 and 156 are the same logical entity, but for different environments.

The SCA 102 also communicates with the LCM observability platform 130 which feeds back information to the SDP agent 128.

The break glass interface is interfaced with one of more of resources 154, 158 All resources are known to the payload observability cloud 132 and are shared with the SDP agent 128.

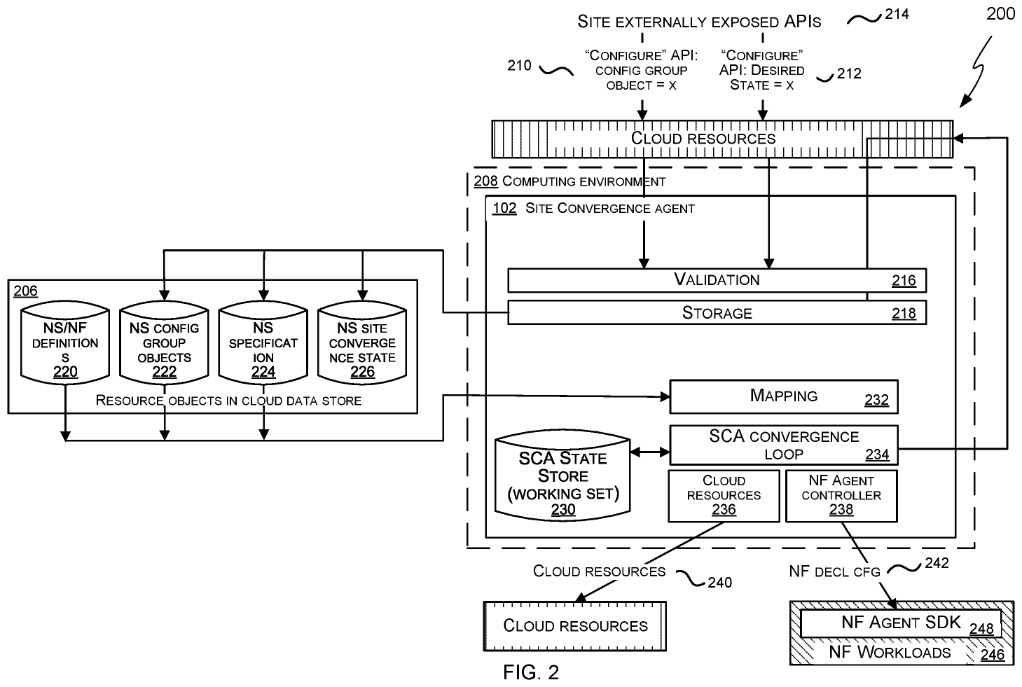

The role of the SCA 102 will now be described in greater detail with reference to FIG. 2. FIG. 2 shows a cloud based system 200 which is used to design and create a network architecture for deployment based on client requirements.

The system 200 includes a processor in the SCA 102, a database of resources 206, and a computing environment 208 in which the SCA 102 is located. The database of resources comprises definitions of cloud and edge resources that the SCA 102 can create and manage, as discussed later. The objects in 206 are a mix of the network service designs, network function designs and configuration parameters provided by designers, publishers and operators respectively.

The SCA 102 has a number of functions according to the present invention. The SCA 102 takes control of determining which resources are required and then determines an order in which the resource need to be deployed in order to implement the required application.

The processor receives information relating to configuration data 210 and convergence data 212 of a desired state from Application Programming Interface (API) 214. The combination serves as a request for a new service, network, application or any other requestor. The processor sends instructions for validation 216 and storage 218 of the input data.

The database 206 includes network service (NS) designs such as network function (NF) definitions 220, NS configuration group objects 222, NS desired state 224 and NS site convergence state 226. The specific instantiation of a particular NS at a particular site is given by the combination of the NS design, the NF definition objects, and the config groups.

The local sub module includes the SCA 102, which includes an SCA state storage 230 which stores the working set at any time in the creation or deployment of the required resources. The SCA 102 includes validation and storage functions 216, 218, a mapping module 232, an SCA convergence loop 234, a cloud processor controller 236 and an NF agent controller 238.

Based on the required network service state the NS and NF designs 220, NS configuration group objects 222 and NS desired state 224 are mapped by a mapping component 232 to the correct NFs and other resources, and passed to a control loop 234 of the SCA 102 for application.

The SCA 102 uses the NS design that defines the whole network service and below this the NFs that need to be created and their associated parameters to implement the network service. The NS design identifies resources and where they should be deployed and a set of complex rules which define the order in which the NFs must be implemented. The NS design includes all the necessary information to find NFs for the network service. If a NF already exists it can be accessed from any appropriate location based on previous information about the NF. If the NF is new a system will need to create the NF. SCA convergence loop 234 communicates with the cloud resources controller 236 and an NF agent controller 238 and requests the generating of new resources in any known manner. The cloud resources controller instantiates cloud resources 240, and the NF Agent controller sends NF declarative configuration via an NF Agent SDK to NF workloads 246. It will be appreciated that there could be more than two different types of controller handling further types of resources. The mapping enables resources to be found and mapped to the required service and provides the order in which the NFs and other resources (such as other cloud resources) are instantiated from the NS design. The SCA convergence loop puts the NFs and other resources in the correct order and gradually instantiates or updates the full working set of the network services, storing its state in the SCA State Store 230.

The SCA 102 also regularly determines a state of convergence to the required network via the SCA convergence loop 234. The SCA convergence loop 234 loops back to the NS site convergence state 226 so that the SCA 102 and the SDP agent 128 are aware of the state of process of putting together the working set which comprises a list of required ordered resources. The SCA loops continues to gather and request NFs and other resources until all resources have been created/updated/deleted.

As previously indicated the NS design includes complex rules on how and in what order to create NFs and other resources to arrive at the required network service. In the present invention the NS design includes the requirements of all necessary levels to implement the service. The levels are hierarchical. The invention enables the identification of and learns that some NSs are able to be combined over one or more level. This gives rise to the creation of patterns which are instantiated rather than individual NSs. The patterns are complex entities that comprise a combination of a number of NSs, a specific order of deploying these NSs or any other parameter. This allows deployment of a combination of infrastructure and application rather than deployment of specific entities such as a single virtual machine.

The order in which the NFs and other resources are to be instantiated is also very complex and includes many streams of task that are able to work in parallel and other streams that are not. The SCA creates an ordering which is based on constraints specified in the NS design.

In addition, there may be a network design making use of one or more other NS designs. A complex network having different parts that can be defined in an NS design and another defined in another NS design. The multiple NS designs can be regarded as network functions in a mega NS design which includes information about how to implement all the NFs in each NS design based on a complex set of ordering rules which require resources from both NS designs to form some of the required functionality.

The continual convergence loop in the SCA 102 ensures that the actual state of the NS (i.e. the NFs and other resources that the mapping has generated) continually evolves towards its desired or required state. Furthermore, if the desired state changes because an operator provides a new desired state, or the actual state diverges such as because of error, the SCA will be able to continue work to enforce convergence. The SCA stores its current working state (i.e. the state of all the NFs and other resources) in the internal SCA state store 230, and when it has reached a converged state or error reports that by storing it in the Site Convergence State 226 which is visible to the operator. It should be noted that the SCA state store 230 may alternatively be external to the SCA.

As the mapping works over multiple levels of the network, a computer ordering can be derived which indicates relationships between NFs and other resources and thus enables an understanding of relationships with multiple level dependence. The system can implement these type of functionality at a quicker rate which adds improvements over known systems and methods.

The working set is a combination of the current state of both NFs and other cloud resources, the set of steps required to reach the desired state, and the progress along those steps. The NS design is at a higher level than some of the levels that are to be deployed via appropriate NFs.

In this way irrespective of the level of the NS design the lower levels are included and have to be instantiated with NFs from other levels in the desired order. In some cases, this means that the lower levels are built first and instantiated first, however that might not always be the case. If redeployment is required, the present invention does not require used input to define layers this is performed automatically. The present invention can thus solve the problem of recovery when a whole data center goes down as it is possible to redeploy it from scratch at another site.

When the working set is complete the SCA 102 will call the processor controller 236 and NF agent controller 238 to instantiate or change specific resources.

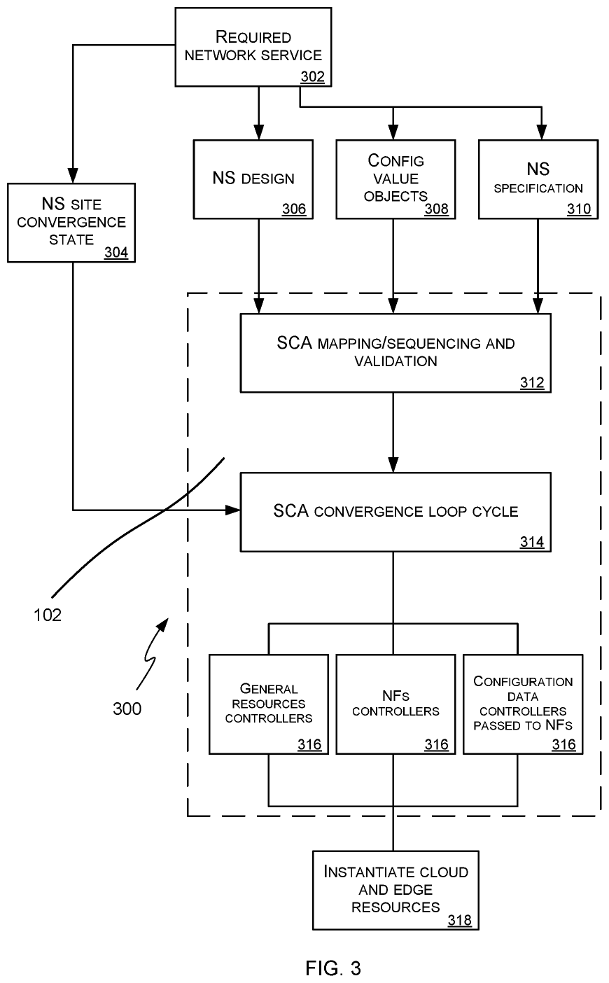

FIG. 3 is a flow chart of a method 300 carried out in accordance with the present invention.

In a first block 302 an operator receives a request to instantiate a required network service. The required network service will be passed to the SCA as a resource, i.e. the SCA is instructed to put make the NS come into existence.

The NS requirement block 302 is of the form “service X should exist with the parameters specified by config groups Y”, which gets stored in the NS desired state 304.

A definition of the required NS creates an NS design 306, a set of configuration values 308 and an NS specification 310.

The SCA then performs mapping or sequencing and validation 312. That mapping outputs a mix of NF and cloud resource definitions, ordered appropriately, as a list or a Directed Acyclic Graph (DAG). The ordered NF and cloud resource definitions are stored as a required state and comprise a plurality of required resources in an ordered list or a required sequence of events.

The SCA convergence loop 314 then sequences through the ordered list by passing each resource to a controller 316 to apply them. There are multiple controllers 316 of different types, one handling NFs, one handling configuration to be passed to NFs, etc. each handling a different type of resource.

Each of the controllers 316 creates, updates, and/or deletes the resources as appropriate and instantiates them 318 to a system such as a cloud platform, an on premises data centre, or some other configuration API. The controller may also return information from the system. For example, if it creates a Virtual Machine (VM) in a cloud environment, it might return the IP address that is then an input to the next required resource to be created.

As the process proceeds, the SCA convergence loop 314 stores data in a working set in a data store within the SCA. The working set stores a record of where it is, i.e. what resources it has already created, updated. and/or deleted. The store is internal and allows the SCA to track which operations have happened, and what they have returned. The working set and the SCA desired state are compared from time to time to establish progress. The SCA uses the NS site convergence state 304 to report back what happened at the NS level, for example: “convergence is ongoing”, “convergence has completed”, or “convergence has failed”

One controller 316 handles NFs, which have their own mapping and convergence logic, and a controller could also create more NSs thereby implying an arbitrary hierarchy of NSs and NFs.

When the SCA has completed processing or when a change is received from the operator the present process stops. In the latter case the entire process is restarted. In this way, changes may be passed to the SCA by the operator, and if the actual state of the system in 318 diverges from the desired state the SCA can update it until it converges to the required state and required ordered resources.

Components of an exemplary computing-based device 400 which are implemented as any form of a computing and/or electronic device, and in which embodiments of an improved site convergence agent on a cloud computing platform and an associated method are implemented in some examples.

Computing-based device 400 comprises one or more processors 402 which are microprocessors, controllers, or any other suitable type of processors for processing computer executable instructions to control the operation of the device. In some examples, for example where a system on a chip architecture is used, the processors 402 include one or more fixed function blocks (also referred to as accelerators) which implement a part of the method of improved site convergence agent and associated method in hardware (rather than software or firmware). Platform software comprising an operating system 404 or any other suitable platform software is provided at the computing-based device to enable application software 406 to be executed on the device.

The computer executable instructions are provided using any computer-readable media that is accessible by computing based device 400. Computer-readable media includes, for example, computer storage media such as memory 408 and communications media. Computer storage media, such as memory 408, includes volatile and non-volatile, removable, and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 408) is shown within the computing-based device 400 it will be appreciated that the storage is, in some examples, distributed or located remotely and accessed via a network or other communication link (e.g., using communication interface 410).

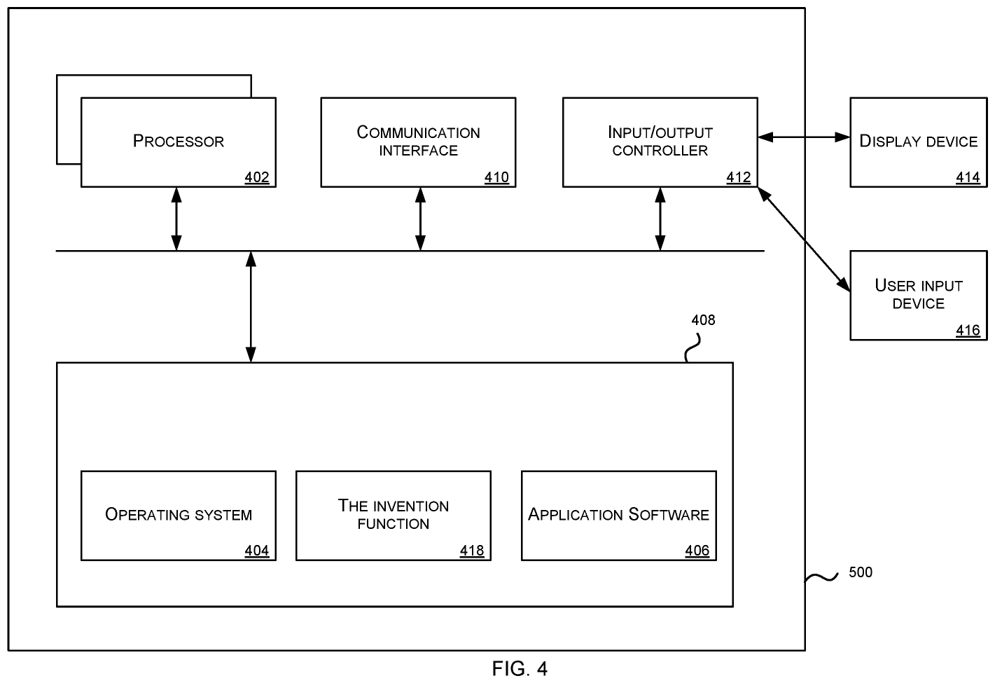

The computer-based device 400 can include other functionality including but not limited to an input/output controller 412 which communicates with an internal or remote display device 414 and an internal or external user input device 416. The SCA 102 on the cloud computing platform 100 and an associated method are implemented within the computing system 418 as shown in FIG. 4. In a cloud based environment some or all of the elements forming part of the computer-based device 400 can be located in a central cloud resource

In an aspect there is provided computer-implemented method for instantiating a network service, comprising: receiving a request for a required network service; determining a required network service (NS) design for the required network service storing a required NS state configured to create a list of required resources in a required order for instantiating the required network service sequencing, through the list of required resources in the required order and identifying a sequence of required resources based on the order; converging towards the sequence of required resources, via a SCA convergence by: (a) implementing the required resource by calling for the required resource to be created, updated or deleted; (b) determining a next required resource to implement; repeating steps (a) and (b) to convergence; comparing the implemented resources with the list of required resource to determine convergence; instantiating, via a controller, the or each implemented resource.

In an aspect, the required NS state identifies a plurality of network functions (NF) required to instantiate the required network service and an ordering list for indicating an order in which the plurality of NFs is to be instantiated.

In an aspect, the required network service comprise a plurality network functions (NF), cloud resources and one or more configuration objects in sub claim.

In an aspect, instantiating each of the required resources to instantiate the required network services.

In an aspect, implementing the required resource from a known resource.

In an aspect, implementing one of the required resources further comprises creating a new resource.

In an aspect, instantiating the NS design to include all levels of the network.

In an aspect, identifying one or more patterns which are complex entities that comprise a combination of one or more required resources and the order associated therewith.

In an aspect, deriving relationships between the required resources and with multiple level dependence to create a new pattern.

In an aspect, generating the NS design from multiple other NS designs.

In an aspect there is provided an apparatus for instantiating a network service comprising: at least one processor; a memory storing instructions that, when executed by the at least one processor, is configured to receive a request for a required network service; determine a required network service (NS) design for the required network service; store a required NS state configured to create a list of required resources in a required order for instantiating the required network service; sequence, through the list of required resources in the required order and identifying a sequence of required resources based on the order; converge towards the sequence of required resources, via a SCA convergence loop by: (a) implementing the required resource by calling for the required resource to be created, updated or delete a resource; (b) determining a next required resource to implement; repeating steps (a) and (b) to convergence; compare the implemented resources with the list of required resource to determine convergence; instantiate, via a controller, the or each implemented resource.

In an aspect, the required NS state identifies a plurality of network functions (NF) required to instantiate the required network service and an ordering list for indicating an order in which the plurality of NFs is to be instantiated.

In an aspect, the required network service comprise a plurality network functions (NF), cloud resources and one or more configuration objects in sub claim.

In an aspect, instantiating each of the required resources in the order to instantiate the required network services.

In an aspect, implementing the required resource from a known resource.

In an aspect, implementing one of the required resources further comprises creating a new resource.

In an aspect, generating the NS design to include all levels of the network.

In an aspect, identifying one or more patterns which are complex entities that comprise a combination of one or more required resources and the order associated therewith.

In an aspect, deriving relationships between the required resources and with multiple level dependence to create a new pattern.

In an aspect there is provided a computerized system for instantiating a network service, comprising: one or more processors; and computer storage memory having computer-executable instructions stored thereon which, when executed by the one or more processors, implement a method comprising: receive a request for a required network service; determine a required network service (NS) design for the required network service; store a required NS state configured to create a list of required resources in a required order for instantiating the required network service; sequence, through the list of required resources in the required order and identifying a sequence of required resources based on the order; converge towards the sequence of required resources, via a SCA convergence loop by: (a) implementing the required resource by calling for the required resource to be created, updated or delete a resource; (b) determining a next required resource to implement; repeating steps (a) and (b) to convergence; compare the implemented resources with the list of required resource to determine convergence; instantiate, via a controller, the or each implemented resource.

In an aspect there is provided a computer implemented method for instantiating a network service in a computing system comprising a plurality of computing devices, the method comprising: receiving a request for the network service; in response to the request, generating a list of required resources in a required order for instantiating the network service, the required resources comprising one or more of infrastructure resources, network function resources, or workload resources; identifying a sequence of the required resources based on the required order; executing a site convergence agent (SCA) convergence loop operable to, for each of the required resources, implement the required resource by calling for the required resource to be created, updated, or deleted; determining a convergence of the required resources to the sequence of the required resources by comparing the implemented required resources with the list of the required resources; and deploying the requested network service by instantiating the implemented required resources.

Alternatively, or in addition, the functionality described herein is performed, at least in part, by one or more hardware logic components. For example, and without limitation, illustrative types of hardware logic components that are optionally used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

What is claimed is:

1. A computer-implemented method for instantiating a network service in a computing system comprising a plurality of computing devices, the method comprising:
receiving a request for the network service;
in response to the request, generating a list of required resources in a required order for instantiating the network service, the required resources comprising one or more of infrastructure resources, network function resources, or workload resources;
identifying a sequence of the required resources based on the required order;
executing a site convergence agent (SCA) convergence loop operable to, for each of the required resources, implement the required resource by calling for the required resource to be created, updated, or deleted;
determining a convergence of the required resources to the sequence of the required resources by comparing the implemented required resources with the list of the required resources; and
deploying the requested network service by instantiating the implemented required resources.

2. The computer-implemented method of claim 1, wherein the required resources are defined by a required network service (NS) state that identifies a plurality of network functions (NF) required to instantiate the network service and an ordering list for indicating an order in which the plurality of NFs is to be instantiated.

3. The computer-implemented method of claim 1, wherein the network service comprises a plurality of network functions (NF), cloud resources, and one or more configuration objects.

4. The computer-implemented method of claim 1, further comprising instantiating each of the required resources to instantiate the network services.

5. The computer-implemented method of claim 1, further comprising implementing the required resource from a known resource.

6. The computer-implemented method of claim 5, wherein implementing one of the required resources comprises creating a new resource.

7. The computer-implemented method of claim 2, further comprising instantiating the NS design to include all levels of a network wherein the network service is instantiated.

8. The computer-implemented method of claim 1, further comprising identifying one or more patterns which are complex entities that comprise a combination of one or more of the required resources and the order associated therewith.

9. The computer-implemented method of claim 8, further comprising deriving relationships between the required resources and with multiple level dependencies to create a new pattern.

10. The computer-implemented method of claim 2, further comprising generating the NS design from multiple other NS designs.

11. A system for instantiating a network service comprising:
at least one processor;
a memory storing instructions that, when executed by the at least one processor, causes the system to perform operations comprising:
receiving a request for the network service;
in response to the request, generating a list of required resources in a required order for instantiating the network service, the required resources comprising one or more of infrastructure resources, network function resources, or workload resources;
identifying a sequence of the required resources based on the required order;
executing a site convergence agent (SCA) convergence loop operable to, for each of the required resources, implement the required resource by calling for the required resource to be created, updated, or deleted;
determining a convergence of the required resources to the sequence of the required resources by comparing the implemented required resources with the list of the required resources; and
deploying the requested network service by instantiating the implemented required resources.

12. The system of claim 11, wherein the required resources are defined by a required network service (NS) state that identifies a plurality of network functions (NF) required to instantiate the network service and an ordering list for indicating an order in which the plurality of NFs is to be instantiated.

13. The system of claim 11, wherein the network service comprise a plurality network functions (NF), cloud resources, and one or more configuration objects.

14. The system of claim 11, further comprising instructions that, when executed by the at least one processor, causes the system to perform operations comprising instantiating each of the required resources in the order to instantiate the network services.

15. The system of claim 11, further comprising instructions that, when executed by the at least one processor, causes the system to perform operations comprising implementing the required resource from a known resource.

16. The system of claim 15, wherein implementing one of the required resources further comprises creating a new resource.

17. The system of claim 12, further comprising instructions that, when executed by the at least one processor, causes the system to perform operations comprising generating the NS design to include all levels of a network wherein the network service is instantiated.

18. The system of claim 11, further comprising instructions that, when executed by the at least one processor, causes the system to perform operations comprising identifying one or more patterns which are complex entities that comprise a combination of one or more of the required resources and the order associated therewith.

19. The system of claim 18, further comprising instructions that, when executed by the at least one processor, causes the system to perform operations comprising deriving relationships between the required resources and with multiple level dependencies to create a new pattern.

20. A computerized system for instantiating a network service, comprising:
one or more processors; and
computer storage memory having computer-executable instructions stored thereon which, when executed by the one or more processors, cause the computerized system to:
receive a request for a required network service;
determine a required network service (NS) design for the required network service;
store a required NS state configured to create a list of required resources in a required order for instantiating the required network service;
sequence through the list of required resources in the required order and identify a sequence of required resources based on the order;
converge towards the sequence of required resources, via a SCA convergence loop, by:
a. implementing the required resource by calling for the required resource to be created, updated or delete a resource;
b. determining a next required resource to implement;
c. repeating steps a and b to convergence;
compare the implemented resources with the list of required resource to determine convergence; and
instantiate, via a controller, the or each implemented resource.
